(19) United States
(12) Patent Application Publication
(10) Pub. No.: US 2012/0173305 A1
(43) Pub. Date: Jul. 5, 2012

(54) MOBILE APPLICATION SURVEYS AND INCENTIVES

(76) Inventor: Vivek Bhaskaran, Seattle, WA (US)

(21) Appl. No.: 13/306,791

(22) Filed: Nov. 29, 2011

Related U.S. Application Data
(60) Provisional application No. 61/417,702, filed on Nov. 29, 2010.

(51) Int. Cl. G06Q 30/02

(52) U.S. Cl. 705/7.32

(57) ABSTRACT

A mobile survey system is described herein that leverages users' appreciation of paid applications and other rewards to incentivize participation in market research surveys. As a user participates in surveys, the system gives the user points that accumulate in an account associated with the user. The points can subsequently be redeemed for paid mobile applications or other incentive compensation, such as products or services. Most application and content stores provide some ability for one user to give another user an application/content or credit for the same as a gift. The system leverages this mechanism to credit users that elect a particular application or content as a reward with the reward of the user's choice. Thus, the mobile survey system increases participation in mobile surveys by incentivizing users in ways that are highly relevant to sought after categories of users.

### CROSS-REFERENCE TO RELATED APPLICATIONS

The present application claims the benefit of U.S. Provisional Patent Application No. 61/417,702 (Attorney Docket No. SURVEY001) entitled “MOBILE APPLICATION SURVEYS”, and filed on Nov. 29, 2010, which is hereby incorporated by reference.

### BACKGROUND

Mobile applications represent a significant portion of the market for software applications today. Platforms such as Apple's iTunes App Store, Google's Android Marketplace, Amazon's Android Marketplace, and others provide applications according to a variety of financial models. Some applications produce revenue through an initial sales price, while others are free and use a “freemium” model to produce revenue through ongoing in-application sales of content. Users like free applications, but many of the best applications are paid applications so that the developer recoups his/her investment of time and resources used to create the application.

Surveys have become a popular way for companies that sell products and services to perform market research. Market research can provide information about tastes and preferences among particular demographic groups, opinions of target users of a product, information about experiences of users with the product or service, and so forth. Some users enjoy taking surveys about the products they enjoy, but others are only interested in surveys for which they receive some compensation for their time.

Getting users to take product research surveys is an ongoing problem. Those users who are willing to take surveys without compensation may not represent all user types from which a researcher is interested in garnering data. Often, the most desirable survey targets will only take the time to answer survey questions with a proper incentive. In addition, even those users that enjoy taking surveys will only answer so many before they choose to do other, more rewarding things. Providing an incentive that is relevant to users at the time of taking a survey is needed to increase survey participation and to grow the base of users willing to take surveys.

### BRIEF DESCRIPTION OF THE DRAWINGS

FIG. 1 is a block diagram that illustrates components of the mobile survey system, in one embodiment.

FIG. 2 is a flow diagram that illustrates processing of the mobile survey system to deliver a survey to a user, in one embodiment.

FIG. 3 is a flow diagram that illustrates processing of the mobile survey system to create a survey for receiving responses from users, in one embodiment.

FIG. 4 is a display diagram that illustrates a user interface for presenting a list of available surveys to a user, in one embodiment.

FIG. 5 is a display diagram that illustrates a user interface for viewing location-based surveys, in one embodiment.

FIG. 6 is a display diagram that illustrates a popup notification for alerting the user to new surveys, in one embodiment.

FIG. 7 is a display diagram that illustrates a user interface for viewing earned points and redeeming the points for rewards, in one embodiment.

### DETAILED DESCRIPTION

A mobile survey system is described herein that leverages users' appreciation of paid applications to incentivize participation in market research surveys. In some embodiments, as a user participates in surveys, the system gives the user points that accumulate in an account associated with the user. The points can subsequently be redeemed for paid mobile applications or other incentive compensation, such as products or services (e.g., t-shirts, gift cards, digital content, and so on). The system allows mobile users to answer questions from market researchers, businesses, and non-profit organizations. Users earn points for answering the questions. The earned points can be redeemed for various kinds of prizes like paid iPhone applications for free, gift cards from major stores, as well as deals from participating partners. The system can also be used by existing market research and panel companies as a data collection platform from members of their existing panels. Most application and content stores provide some ability for one user to give another user an application/content or credit for the same as a gift. The system leverages this mechanism to credit users that elect a particular application or content as a reward with the reward of the user's choice. Thus, the mobile survey system increases participation in mobile surveys by incentivizing users in ways that are highly relevant to sought after categories of users.

An example process employed by the system is described in the following paragraphs. In some embodiments, the user first downloads a survey application to the user's mobile device. For example, the survey application may be listed in an application store associated with the user's mobile device (e.g., the application SurveySwipe listed in the Apple App Store, Android Marketplace, and elsewhere). The user may also receive an email link to the application from another user or from a company from which the user has purchased products or services or that performs market research. The application installs on the user's mobile device and allows the user to participate in one or more surveys for conducting market research or gathering other information. By installing the application, the user can run the application to view available surveys, and the application can use facilities of the mobile device platform, such as push notifications, to inform the user of new surveys.

In some embodiments, the user next registers with the mobile survey system. For example, a user may create an account by providing a username (e.g., email address) and password that distinguishes the user from other users. The system may create a profile for the user in which the system stores information about the user, such as demographic information, past surveys taken by the user, a record of any points earned by the user for participating in surveys, past product purchases, and so forth. In some embodiments, the system requests demographic information from the user during creation of the profile. For example, the system may request the user's gender, zip code, age, income level, occupation, entertainment preferences, product preferences, and other information used by market research sources to identify one or more demographic groups of the user. The user may also register a category or other identification of types of surveys that the user is interested in, such as by product type, by industry, by location, and so forth.

In some embodiments, the system invites the user to participate in surveys after the user registers with the system. For example, the system may automatically match the user with various surveys based on available surveys known to the system and information in the user's profile that indicates that the user is an appropriate match for the information a particular survey source is trying to gather. The system may provide a notification to the user that a survey is available, such as via email, a push notification, text message, or other communication facility.

Companies and market research agencies commission surveys. In some embodiments, the system provides a web interface through which companies can develop surveys and deploy them for participation by users of the system. The system may also provide profiles through which companies register and identify themselves to the system. A company may provide information such as a level of monetary reward the company is willing to pay for each completed survey, a target end date of the survey, the type of users that the company would like to participate in the survey, and so forth. A company may have multiple surveys registered with the system at a single time and may provide different target and compensation information for each survey. In some cases, a company pays the operator of the system a fixed or lump fee for handling the survey and the operator uses a portion of the fee to create incentives for users. In such cases, the operator rather than the company sets and determines the types and levels of incentives. In some cases, the operator may be paid by the company based on how many respondents the operator gets to take the survey, such that the operator has an incentive to increase survey participation.

In some embodiments, a user next completes a survey. The survey itself may include a variety of user interface elements that gather the user's responses to questions. For example, the user interface may include radio buttons with which the user can respond to multiple-choice questions, text input boxes for receiving information typed through a mobile or on-screen keyboard, areas the user can swipe on a touch screen to indicate a response, and so forth. The user goes through one or more questions at a time. In some embodiments, the mobile survey system provides a rating and slider interface for matrix questions. A user can use the interface to rate an item between two extremities. For example, on the left may be the text “agree” and on the right “disagree” so that the user can place the slider at some scale in between to indicate a level of agreement or disagreement with the question or statement provided by the survey. As the user moves the slider, the text can dynamically change to indicate the selection being made. As the user leaves the slider, the text is “pinned” to a particular selected value.

In some embodiments, the user receives points for participation in surveys. Points can be determined based on complexity of the survey, points designated by the survey source, value of the user's demographic group to the survey source, and so on. For example, doctors may get more for their time than stay-at-home moms do, based on supply and demand. Upon completion of a survey, the user may receive points or the system may perform a validation process to ensure that users are not rushing through surveys just to earn points. For example, the system may analyze the amount of time the user spent completing the survey, how much the user interacted with the user interface (e.g., did the user move any sliders or select any answers or just accept a default value), and other factors to determine the user's level of participation.

In some embodiments, the system next provides the user with redemption options for redeeming points. The redemption options may include a list of applications that the user can select. Many mobile platforms provide an ability to “gift” paid applications to other users. The system can use this ability to allow a user to select a paid application, redeem points for the cost of the application, and then gift the application to the user. The system provides the payment to the application developer in dollars or other currency while compensating the user with points and the received application. In effect, any paid application for which the user has earned sufficient points can be redeemed at no monetary cost from the user's perspective. In some embodiments, the system may filter applications based on particular criteria, such as whether the user has enough points to purchase the application. The system may also allow the user to partially use points and combine a payment to purchase an application. For example, if an application is $5 and the user has $3 worth of points, then the user may redeem points and pay an additional $2 to purchase a $5 application. In this case, the user still benefits from taking surveys by receiving a discount on the cost of the application for a modest investment of time.

In some embodiments, the system supports redemption of points for other content, such as that provided by Apple iTunes, including music, television shows, movies, books, and so forth. The system may also allow the user to redeem points for gift certificates or to gift applications to other users (e.g., a family member).

Thus, the mobile survey system collects valuable market research data for survey sources while providing users with a way to obtain paid applications and other content without payment. The user invests a modest amount of time completing surveys that interest the user, and the system rewards the user with points redeemable for applications and other content. Market researchers get higher participation in surveys and users get more of the applications they want.

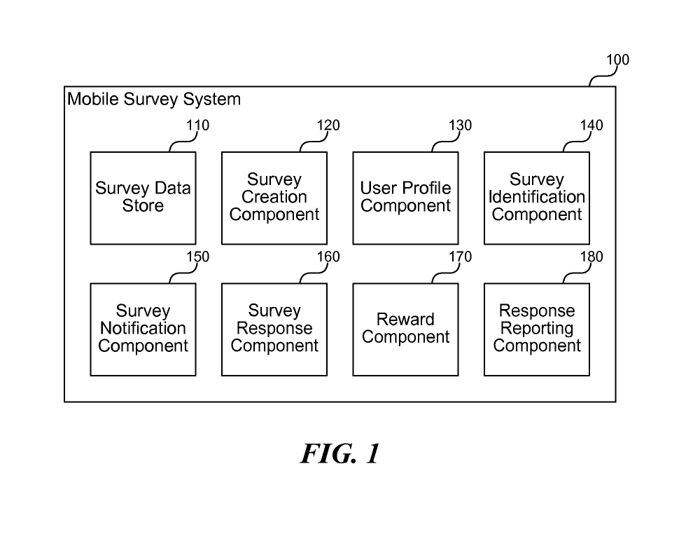

FIG. 1 is a block diagram that illustrates components of the mobile survey system, in one embodiment. The system 100 includes a survey data store 110, a survey creation component 120, a user profile component 130, a survey identification component 140, a survey notification component 150, a survey response component 160, a reward component 170, and a response reporting component 180. Each of these components is described in further detail herein.

The survey data store 110 stores one or more surveys created by a researcher for delivering to users from which to obtain survey responses. The survey data store 110 may include one or more files, file systems, hard drives, databases, storage area networks, cloud-based storage services, or other facilities for storing data persistently. The system 100 may provide separate interfaces, one through which survey-creating researchers access the system 100 to create surveys, and another through which survey users access the system 100 to take surveys. The researchers create surveys by devising a set of questions stored as a survey in the survey data store 110. The researchers may also add information describing target user groups for taking the survey, incentives available to those that take the survey, a fee paid to the system 100 operator, any limits on time and/or responses for the survey, and so forth.

The survey creation component 120 provides an interface through which survey-creating researchers create surveys for delivery to survey-taking users. The interface may include one or more web pages, desktop applications, mobile applications, programmatic interfaces, or other interfaces through which survey data can be specified. The survey creation component 120 receives information describing survey questions, question types, allowable responses (e.g., yes/no, multiple choice, and so forth), target users for taking the survey, incentives available for taking the survey, and so on. In some embodiments, the survey creator pays an amount of money to the system 100 operator for hosting and obtaining responses to the survey. The survey creator may provide an additional incentive for each response received or for hitting a particular response target (e.g., 1,000 survey responses) or time target (e.g., 1,000 responses in a week). From this information the system 100 operator may devise an incentive scheme that maximizes survey returns as well as profit of the system 100 operator.

The user profile component 130 stores information describing one or more users that take surveys through the system. The information may include authentication information (e.g., a username and password), contact information (e.g., an email address and/or mobile phone number), demographic information (e.g., the user's age, gender, political preference, religious affiliation, income level, number of children, marital status, and so forth), and other information related to the user. The system 100 uses information stored in the user profile component 130 to identify surveys that match particular user criteria based on requested user characteristics of survey creators. The user profile component 130 also stores reward status information for each user, which may include a count of points or other incentives earned, past redemptions of points, reward types that the user likes, and so on. The system 100 may use historical information derived from the user's profile to select appropriate future surveys and incentives to offer to the user. For example, the system 100 may observe that one user is particularly motivated by offers of free applications while another user is motivated by monetary discounts on goods or services. The system 100 can offer each user a reward most likely to motivate that user.

The survey identification component 140 identifies one or more surveys appropriate for an identified user based on criteria specified by each survey-creating researcher associated with each survey and information associated with the identified user based on the user's profile information. Some surveys may be identified as appropriate for all users while other surveys may target particular users, such as a particular gender, customers of a particular store, users that have been to or left a particular location (e.g., as determined by a global positioning system (GPS) or other location sensing component of the user's mobile device), and so forth. The system 100 may invoke the survey identification component 140 when a new user joins the system 100 by creating a user profile, when a user opens a mobile or other application associated with the system 100, periodically based on time criteria, as new surveys or added, or based on any other criteria as a result of which new surveys may match a particular user or users.

The survey notification component 150 notifies the identified user when one or more surveys are available for which the user is a match based on the survey criteria. The notification may include a push notification to the user's mobile device, a text message, an email message, or any other type of notification that the user can receive. The survey notification component 150 may leverage contact information for the user stored in the user's profile, as well as any contact preferences that the user has specified. The notification may include information such as the survey name or descriptive information, a reward available for taking the survey, and any other relevant information related to the survey (e.g., a time limit for taking the survey, a source of the survey, and so on). The survey notification component 150 provides proactive notification to the user of matching surveys in addition to any explicit actions of the user (e.g., opening a survey application) to find matching surveys.

The survey response component 160 receives user responses to an identified survey through a user interface provided to the user for taking the identified survey. The system 100 may provide standard controls for particular question types, and the survey may be made up of a survey definition defined in the survey creation process that specifies types of questions, text for each questions, allowable responses, and so forth. As the user takes the survey, the user interface may present one or more questions in succession and receive a type of input (e.g., Boolean, multiple choice, freeform text, and so on) appropriate for the defined question type. The system 100 may validate each user response, and then records the response for later reporting to the researcher that created the survey. In some embodiments, the system 100 invokes a validation layer that compares the user's responses with known information associated with the user (e.g., from the user's profile). For example, if the user's profile indicates that the user is male, and the user's response to a gender question indicates that the user is female, then the survey response may be deemed untrustworthy. The system 100 may also apply other heuristics. For example, if the user selected the first option for every multiple-choice question, then the system may mark the user's responses as suspect. In this way, the survey response component 160 may generate a level of confidence in a particular user response to a survey, and this level of confidence may affect the user's rewards and invitation to future surveys.

The reward component 170 tracks rewards earned by a user for taking identified surveys and reward redemptions requested by the user for redeeming rewards for goods or services. The reward component 170 may track a set of points or other denomination of reward in the user's profile that indicates a value of the user's contributions through survey responses. The component 170 may provide a user interface through which the user can view available rewards and select a reward on which to redeem the user's points. For example, the rewards may include an ability to redeem a value of the user's past survey responses for paid applications in a mobile application store. The rewards may also include gift cards, discounts, content, monetary payments, or other incentives to encourage the user to take surveys and to provide trustworthy responses. In some embodiments, the component 170 assigns a point value to the user's survey submissions based on a measure of trustworthiness of the user's response. Trustworthiness may be determined by accuracy of the user's responses, speed with which the user took the survey, likelihood of the user's answers (e.g., selecting the same choice for each multiple choice question versus a more random distribution of choices), and so on.

The response reporting component 180 provides an interface to survey-creating researchers for receiving survey responses from survey-taking users. The component 180 may provide responses directly, anonymized responses that remove user information, summary information that rolls up data from multiple responses, and so forth. The component 180 may provide a variety of types of reports and data export options that researchers can use to extract the information they want to use from survey results. The component 180 may provide one or more web pages, applications, programmatic interfaces, or other interfaces for researches to gain access to survey information.

The computing device on which the mobile survey system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

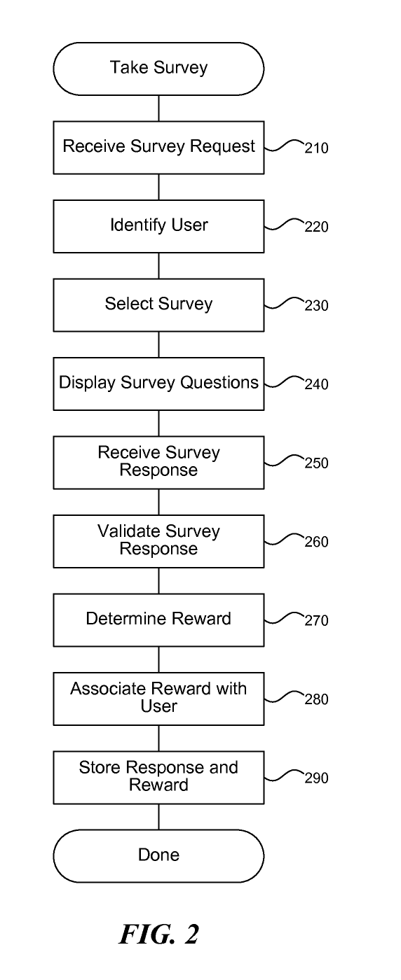

FIG. 2 is a flow diagram that illustrates processing of the mobile survey system to deliver a survey to a user, in one embodiment.

Beginning in block 210, the system receives a request to take a survey from a user. The system may receive the request explicitly, such as via the user opening a survey-taking application associated with the system, or implicitly, such as by the fact that a user has registered a user profile with the system and new surveys are available to which the user could respond. The request may come through an application or other interface for which the user has provided authentication information (either presently or earlier via information stored in a cookie) that the system can use to identify the user.

Continuing in block 220, the system identifies the user that submitted the request and accesses profile information associated with the user. The system may identify the user based on a username, other logon information, stored credential information, and so on. Once the user is identified the system can access user profile information associated with the user that may indicate types of surveys the user is interested in, surveys for which the user meets particular participation criteria (e.g., based on the user's demographic information or current location), and so forth.

Continuing in block 230, the system selects at least one survey to deliver to the user for receiving a survey response. The system may automatically select a survey for which the user is eligible or may receive a selection from the user via a user interface of a survey that the user wants to take. If the system selects, the system may do so based on compensation provided to the system operator for delivering the survey, a level of match between the survey criteria and user information, a priority or deadline associated with the survey, and so on. This allows the system operator to prioritize and receive responses for surveys that may be expiring soon or for which user responses are in higher demand.

Continuing in block 240, the system displays one or more survey questions in a user interface through which the identified user can respond to each question. The system may provide a wizard-like interface that displays each question to the user in succession, may provide a scrollable page of questions, or any other format chosen by the survey creator or system operator for delivering surveys to users. The questions may include various question types, such as yes/no, multiple choice, freeform text, sliders, dials, or other types of questions. The response to each question includes a type of input appropriate for each question type.

Continuing in block 250, the system receives a survey response, where a survey response includes the user's answers to each of the displayed survey questions. In some cases, a user may be able to decline to respond to particular questions or provide a “not applicable” or “no comment” type of response. The survey response is the aggregation of the user's responses to each question of the survey. The system may receive the responses via a web page, mobile application, or other interface and may collect and store responses at a central server, cloud-based service, or other facility from which the responses can be accessed and later analyzed and reported.

Continuing in block 260, the system optionally validates the survey response to detect invalid or untrustworthy responses. The system may assign a quality score or other metric to the survey response that indicates a determined validity of the response. For example, if the user spent only a few seconds on a long survey, then the user's responses may be deemed less valid than if the user spent a threshold amount of time per question indicative of a well thought out response. The system may throw out invalid responses or may weight responses based on quality score to give less weight to suspect responses.

Continuing in block 270, the system determines a reward to assign to the user based on the response received from the user and reward information associated with the selected survey. The reward may include points defined by the system, redeemable for applications from an application store, content, or other goods or services. The system may display the potential reward to the user before the user takes the survey and then provide the reward to the user upon completion of the survey. In some cases, the system may determine the reward or magnitude of the reward based on a determined validity of the user's response. In some cases, the user may accumulate points over time and redeem the points at some future time chosen by the user. For example, the user may try to build up enough points to redeem for rewards that take an amount of points only achievable by taking multiple surveys.

Continuing in block 280, the system associates the determined reward with the profile information associated with the user. The system may add points to a point count stored in the user's profile or may directly allow the user to redeem the reward for goods and services. For some surveys, the survey creator or system operator may provide a one to one relationship between a particular survey and reward (i.e., “take this survey, receive this reward”).

Continuing in block 290, the system stores the received survey response and determined reward in a data store. The data store persists response information so that survey responses can be analyzed and reported by the system to survey creators and persists reward information so that users of the system can accumulate and redeem rewards over time. After block 290, these steps conclude.

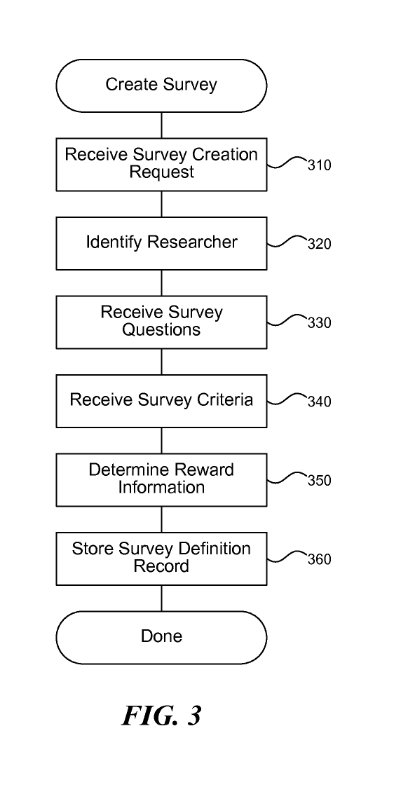

FIG. 3 is a flow diagram that illustrates processing of the mobile survey system to create a survey for receiving responses from users, in one embodiment.

Beginning in block 310, the system receives a survey creation request from a researcher through a survey creation user interface. The system may provide a web page, mobile application, programmatic, or other interface through which researchers can submit surveys to the system for delivery to users. The system may include various payment models, such as a fee per survey, a fee per user response, a subscription model that allows a researcher to submit a particular number of surveys in a period, and so forth. When a researcher accesses the survey creation user interface, the system performs the following steps.

Continuing in block 320, the system identifies the researcher that submitted the request. The system may store user profile information for researchers similar to that stored for survey-taking users. The user profile of a researcher may include subscription and/or payment information, past surveys submitted by the researcher, reports available to the researcher detailing survey responses, and so on. The system identifies the researcher through logon information or other credentials provided to the system to verify the researcher's identity. The researcher may include an individual acting on his own behalf as well as on behalf of a corporation, non-profit, or other entity that is conducting market research.

Continuing in block 330, the system receives one or more survey questions that define a new survey being submitted by the researcher. The questions may each include a question type, question text, available answer choices, value validation information (e.g., a number field limited to numbers from 1 to 10), and so forth. The system may provide various interfaces through which the researcher can design, layout, format, and order survey questions.

Continuing in block 340, the system receives survey criteria that indicate target user types for taking the survey. The criteria may include demographic information, location information (e.g., users near a particular store), time-based information, and other criteria for selecting users. The criteria may also include any limits on the survey, such as a deadline for receiving responses, minimum and maximum numbers of desired responses, and so on.

Continuing in block 350, the system determines reward information to associate with the new survey. The system may automatically determine reward information or may receive reward information from the researcher. For example, a researcher may be willing to spend a certain amount of money per survey response, or an overall amount of money for all survey responses. In some cases, researchers may build up points like other users, and may be able to offer points as a reward to users taking the survey. The system may also automatically determine reward information based on how much the system operator is being paid for hosting the survey and any value assigned by the researcher to each user response or groups of user responses.

Continuing in block 360, the system stores the received survey questions, survey criteria, and determined reward information in a survey definition record associated with the new survey. The system may store the record in a data store of surveys available for users to take, and may record user responses in association with the survey record. As users respond to the survey, they earn the reward determined for the survey. After block 360, these steps conclude.

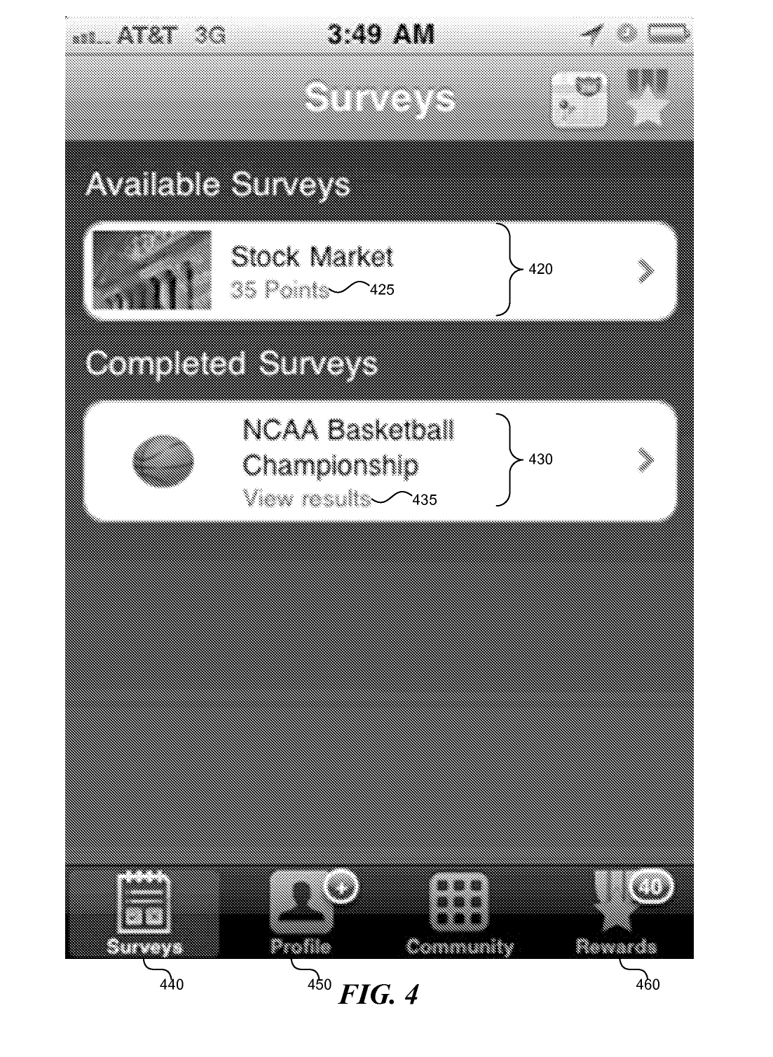

FIG. 4 is a display diagram that illustrates a user interface for presenting a list of available surveys to a user, in one embodiment. The display in the example is that of a mobile application implemented as part of the mobile survey system running on an Apple iPhone, although the system may also provide web-based interfaces, or applications for other platforms. The display includes a list of available surveys, such as a stock market survey 420, and a list of completed surveys, such as a basketball survey 430. The stock market survey 420 indicates a number of points 425 that the user can earn for completing the survey. The completed basketball survey 430 provides a link 435 for viewing results of the survey, including any rewards earned. The display also includes buttons for accessing various parts of the application, including a surveys button 440 for accessing the currently displayed list of surveys, a profile button 450 for viewing and modifying profile information of the user of the application, and a rewards button 460 through which the user can view and redeem awards points for applications, content, discounts, or other goods and services.

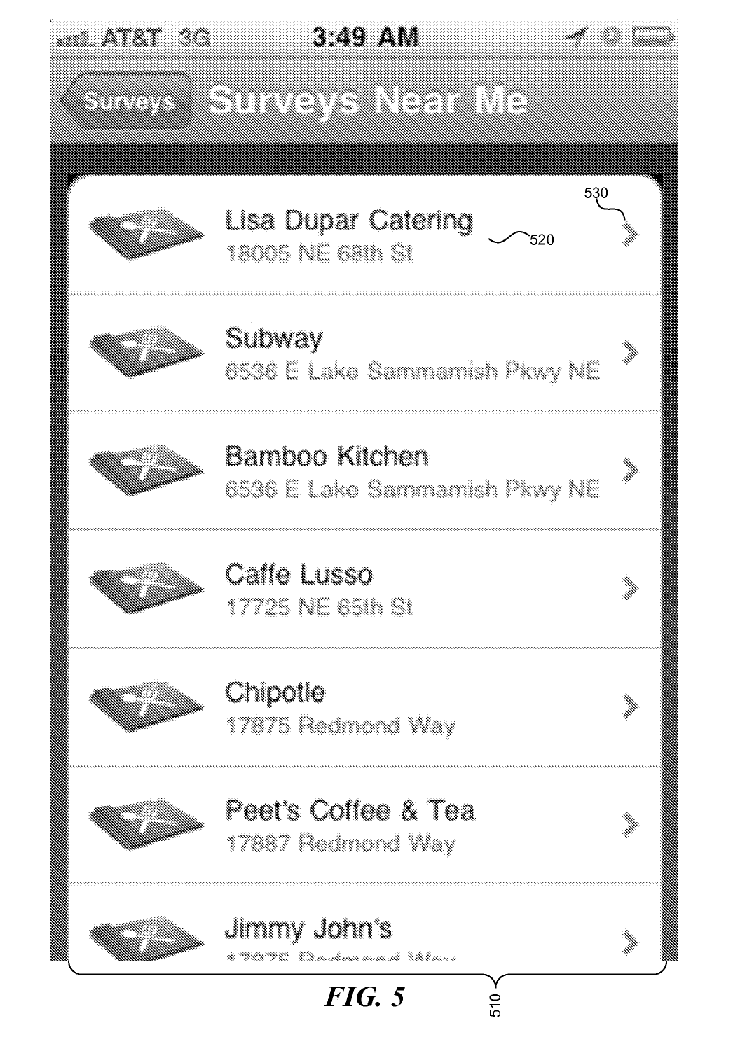

FIG. 5 is a display diagram that illustrates a user interface for viewing location-based surveys, in one embodiment. Location-based surveys are those determined based on a current location of the user. For example, if the user is near a coffee shop and the shop owner has defined a survey, then the user may receive an indication that the coffee shop survey is available while the user is within a limited distance of the coffee shop. This display includes a list of surveys 510, such as the survey 520 for Lisa Dupar Catering. Each survey includes a control 530 that the user can select to view and take the survey. The system may also display other information such as available points for taking the survey, the address of a business associated with the survey, and so forth.

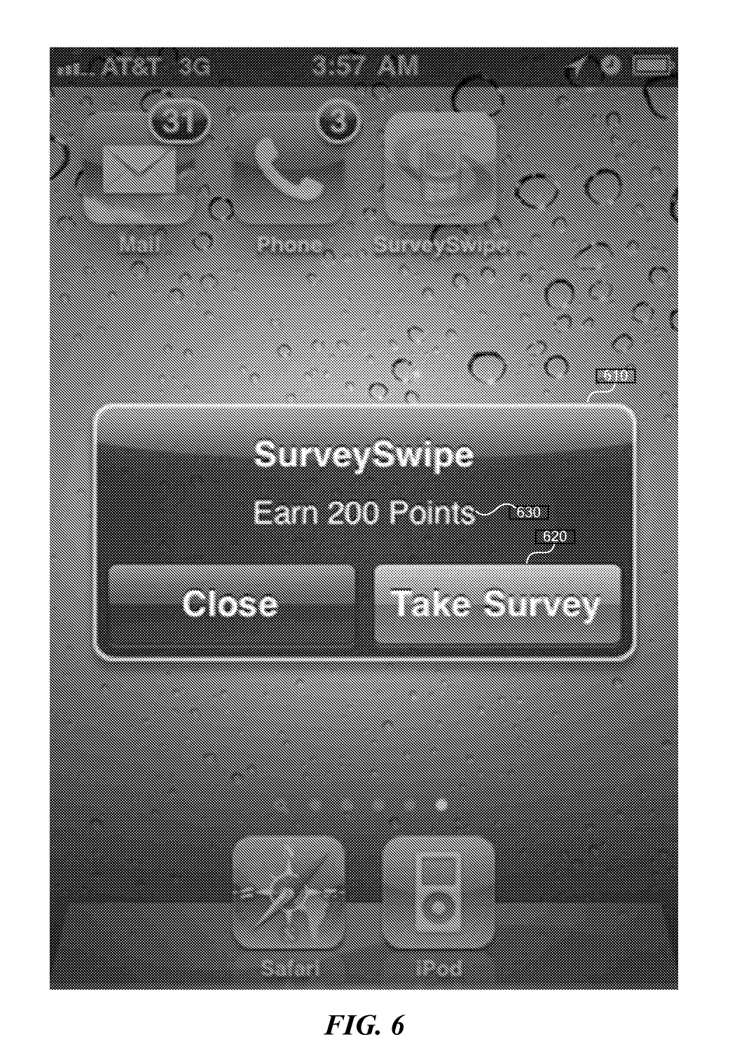

FIG. 6 is a display diagram that illustrates a popup notification for alerting the user to new surveys, in one embodiment. The popup notification includes a textual dialog box 610. Mobile platforms today often include an application-programming interface and platform service for sending push notifications to users that are displayed regardless of which application the user is currently running or what the user is currently doing. The dialog box 610 identifies a particular survey by name, includes a button 620 for taking the survey, and includes reward information 630 that describes what the user can earn for taking the survey. The user may close the notification or elect to take the survey and earn the displayed reward.

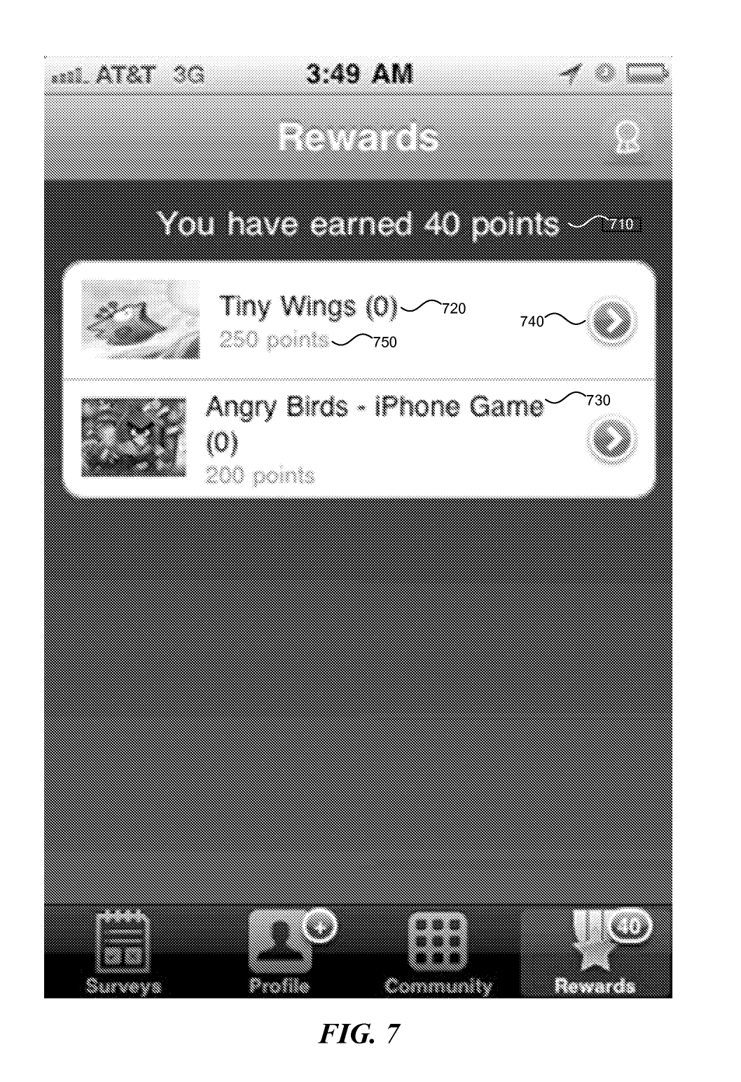

FIG. 7 is a display diagram that illustrates a user interface for viewing earned points and redeeming the points for rewards, in one embodiment. The interface includes a point total 710 that displays the user's earned points, as well as one or more available rewards, such as the Tiny Wings game reward 720 and the Angry Birds game reward 730. The user can activate controls on each reward, such as the button 740 to view more information about the reward and to redeem the user's points to obtain the reward. Each reward may also display a points value 750 needed to redeem the reward. In the illustrated example, the user does not have enough sufficient points yet for either reward, but may be able to combine points and a payment to achieve a discount on either game. The user may also go take additional surveys to earn sufficient points to earn either game.

From the foregoing, it will be appreciated that specific embodiments of the mobile survey system have been described herein for purposes of illustration, but that various modifications may be made without deviating from the spirit and scope of the invention. Accordingly, the invention is not limited except as by the appended claims.

I/We claim:

1. A computer-implemented method to deliver an electronic survey to a user, the method comprising:
receiving from a user a request to take an electronic survey;
identifying the user that submitted the request and accessing profile information associated with the user;
selecting at least one survey to deliver to the user for receiving a survey response;
displaying one or more survey questions in a user interface through which the identified user can respond to each question;
receiving a survey response, where a survey response includes the user's answers to each of the displayed survey questions;
determining a reward to assign to the user based on the response received from the user and reward information associated with the selected survey;
associating the determined reward with the profile information associated with the user; and
storing the received survey response and determined reward in a data store,
wherein the preceding steps are performed by at least one processor.

2. The method of claim 1 wherein receiving the survey request comprises receiving the request explicitly via the user opening a survey-taking application.

3. The method of claim 1 wherein receiving the survey request comprises receiving the request implicitly by the fact that a user has registered a user profile and new surveys are available to which the user could respond.

4. The method of claim 1 wherein identifying the user comprises identifying the user based on a username, other logon information, or stored credential information.

5. The method of claim 1 wherein accessing user profile information comprises accessing information that indicates types of surveys the user is interested in and surveys for which the user meets particular participation criteria.

6. The method of claim 1 wherein selecting at least one survey comprises automatically selecting a survey for which the user is eligible based on profile information and one or more survey criteria.

7. The method of claim 1 wherein selecting at least one survey comprises receiving a selection from the user via a user interface of a survey that the user wants to take.

8. The method of claim 1 further comprising, after receiving the survey response, validating the survey response to detect invalid or untrustworthy responses and assign a quality score to the survey response that indicates a determined validity of the response.

9. The method of claim 1 wherein determining the reward comprises determining points associated with the selected survey that are redeemable for applications from an application store, content, or other goods or services.

10. The method of claim 1 wherein determining the reward comprises determining a particular good or service offered as an incentive for providing the survey response.

11. The method of claim 1 wherein associating the determined award comprises adding a points value of the reward to a point count stored in the user's profile.

12. The method of claim 1 wherein storing the received survey response and determined reward comprises storing information in a centrally accessible data store that can be retrieved from other devices later to provide reports of survey responses and to redeem rewards.

13. A computer system for hosting mobile application surveys and incentives, the system comprising:
a processor and memory configured to execute software instructions embodied within the following components;
a survey data store that stores one or more surveys created by a researcher for delivering to users from which to obtain survey responses;
a survey creation component that provides an interface through which survey-creating researchers create surveys for delivery to survey-taking users;
a user profile component that stores information describing one or more users that take surveys through the system;
a survey identification component that identifies one or more surveys appropriate for an identified user based on matching criteria specified by each survey-creating researcher for each survey and information associated with the identified user based on the user's profile information;
a survey notification component that notifies the identified user when one or more surveys are available for which the user is a match based on the survey criteria;
a survey response component that receives user responses to an identified survey through a user interface provided to the user for taking the identified survey;
a reward component that tracks rewards earned by a user for taking identified surveys and reward redemptions requested by the user for redeeming rewards for goods or services; and
a response reporting component that provides an interface to survey-creating researchers for receiving survey responses from survey-taking users.

14. The system of claim 13 wherein the survey data store includes information for each survey that includes one or more of a set of questions, target user groups for taking the survey, incentives available to those that take the survey, a fee paid to a system operator, and limits on time for taking the survey.

15. The system of claim 13 wherein the survey creation component receives information indicating one or more incentives available to users for taking the survey.

16. The system of claim 13 wherein the user profile component stores reward status information for each user that includes at least one of a count of points or other incentives earned, past redemptions of points, and reward types that the user prefers.

17. The system of claim 13 wherein the survey response component generates a level of confidence in a particular user response to a survey and applies the level of confidence to determine the user's reward for taking the survey.

18. The system of claim 13 wherein the reward component tracks a set of points or other denomination of reward in the user's profile that indicates a value of the user's contributions through survey responses.

19. The system of claim 13 wherein the reward component provides a user interface through which the user can view available rewards and select a reward for which to redeem the user's points.

20. A computer-readable storage medium comprising instructions for controlling a computer system to create a survey for receiving responses from users, wherein the instructions, upon execution, cause a processor to perform actions comprising:
receiving a survey creation request from a researcher through a survey creation user interface;
identifying the researcher that submitted the request;
receiving one or more survey questions that define a new survey being submitted by the researcher;
receiving one or more survey criteria that indicate target user types for taking the survey;
determining reward information to associate with the new survey, wherein the reward information specifies a reward a user will receive for taking the survey; and
storing the received survey questions, survey criteria, and determined reward information in a survey definition record associated with the new survey.
